(19) United States
(12) Patent Application Publication
(10) Pub. No.: US 2010/0088140 A1
(43) Pub. Date: Apr. 8, 2010

(54) AUTOMATED SYSTEMS AND METHODS FOR TIME MANAGEMENT

(76) Inventors: Lahav Gil, Toronto (CA); Aviad Goz, Cesarea (IL); Igal Roytblat, Richmond Hill (CA); Moshe Ben-Shlomo, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/573,562

(22) Filed: Oct. 5, 2009

Related U.S. Application Data
(60) Provisional application No. 61/103,119, filed on Oct. 6, 2008.

(51) Int. Cl. G06Q 10/00; G06F 3/048

(52) U.S. Cl. 705/8; 705/11; 705/301; 715/764

(57) ABSTRACT

Productivity and efficiency may be improved by eliminating or reducing interruptions by providing indications of availability for individuals where are based on a current activity in which the individual is employed. Current activity may be set manually be the individual or automatically, for example by monitoring applications and/or electronic devices with which the individual interacts. Indicator may be positioned on or proximate desktops, doors or sent electronically to computers and communication devices. Relationships between availability and activities may be set by the individual and/or a system administrator. Electronic communication may be suppressed based on the current activity. Relationships between activities or availability and the type of electronic communication suppressed or originator of the communication may be set by the individual and/or system administrator.

### CROSS REFERENCE TO RELATED APPLICATIONS

This application claims benefit under 35 U.S.C. 119(e) of U.S. Provisional Patent Application Ser. No. 61/103,119, filed Oct. 6, 2008 and entitled “AUTOMATED SYSTEMS AND METHODS FOR TIME MANAGEMENT,” which is incorporated herein by reference in its entirety.

### BACKGROUND

1. Technical Field

This description generally relates to automated systems and methods to increase individual efficiency.

2. Description of the Related Art

People at their work place are often disturbed by managers and peers, which interrupts the person's concentration, reducing their efficiency and productivity. Declining an interruption by a colleague or manager may be perceived as rude behavior, hence workers will typically allow such interruptions. Alternatively, a worker may keep a door to an office closed to avoid such interruptions, but that unfortunately also discourages necessary or productive discourse.

Typically, meeting rooms and lecture halls are considered places where interruptions are not acceptable, and people tend to avoid disturbance in such places. Even when a person works in an office/cubical, people sometimes are considerate, passing by without interruption. When the individual, however, is part of a computer network and/or connected to other communication means, his/her colleague has no way to determine if the person is busy or free for communication.

While at their desk, workers may or may not be available for interacting with others depending on the current task they are performing. Avoiding interruptions at inopportune times may greatly enhance work productivity. Thus, there is a need for new approaches to achieving such.

### BRIEF SUMMARY

A method of providing prioritized availability information may be summarized as including receiving at least one user input via at least one user interface; mapping a plurality of activities to a number of availability statuses based on the received user input, at least some of the activities associated with specific applications executable on a computing system; at least partially automatically identifying a currently active activity associated with a specific user; and providing an indication indicative of an availability status for the specific user based at least in part on the identified currently active activity associated with the specific user and based at least in part on the availability status for the activity specified for the currently active activity status by the mapping. At least one of the user inputs may be received from a computer logically associated with the specific user. At least one of the user inputs may be received from a computer that is not logically associated with the specific user. Mapping a plurality of activities to a number of availability statuses based on the received user input may include mapping a first computer-executable application to a first availability status and mapping a second computer-executable application to a second availability status. Mapping a plurality of activities to a number of availability statuses based on the received user input may include mapping at least one of a telephone usage activity or a voicemail usage activity to at least one of the availability statuses. Mapping a plurality of activities to a number of availability statuses based on the received user input may include mapping at least one of a mobile device usage activity to one of the availability statuses. Mapping a plurality of activities to a number of availability statuses based on the received user input may include mapping at least one of a word processor activity or a spreadsheet activity to at least one of the availability statuses. Mapping a plurality of activities to a number of availability statuses based on the received user input may include mapping a meeting indicator in an electronic calendar application to one of the availability statuses. At least partially automatically identifying a currently active activity associated with a specific user may include automatically identifying any specific applications currently executing on a computer logically associated with the specific user. At least partially automatically identifying a currently active activity associated with a specific user may include automatically identifying a specific application associated with a currently selected window on a computer logically associated with the specific user. At least partially automatically identifying a currently active activity associated with a specific user may include automatically determining which application executing on a computer logically associated with the specific user received a most recent input. At least partially automatically identifying a currently active activity associated with a specific user may include automatically determining a duration since a most recent user input to at least one application executing on a computer logically associated with the specific user; computationally comparing the determined duration to a threshold duration; identifying the at least one application executing on the computer logically associated with the specific user as not currently active if the determined duration is greater than the threshold duration; and identifying the at least one application executing on the computer logically associated with the specific user as currently active if the determined duration is not greater than the threshold duration.

The method of may further include monitoring for additional user inputs on a computer logically associated with the specific user received a most recent input; and updating the current active activity accordingly. Providing an indication indicative of an availability status for the specific user may include providing an indication via an indicator positioned at least proximate a location of the specific user. Providing an indication indicative of an availability status for the specific user may include transmitting a signal to a device from which an inquiry regarding a current available status for the specific user originated.

The method may further include presenting a plurality of preconfigured activity and availability relationships for selection via the user interface.

The method may further include in response to one of the activities being determined to be the current activity, preventing incoming electronic communications based on a respective one of the availability statuses mapped to the activity. The method may further include in response to one of the activities being determined to be the current activity, preventing alerts to the specific user that are indicative of incoming electronic communications based on a respective one of the availability statuses mapped to the activity.

The method may further include receiving at least one user input via the at least one user interface that associates a number of forms of electronic communication that are to be suppressed with at least one of the activities or the availability statuses. The method may further include receiving at least some of the user input from a mobile communications device. The method may further include tracking time by application and file name for billing based on project task list or for productivity tracking. The method may further include providing an indication of a current availability status on a device operated by the specific user.

The method may further include receiving at least one user input via the at least one user interface that identifies at least one of a person or a group of persons that are to be blocked from communicating with the specific user; providing corresponding notification to the person or the group of persons in response to an attempt to contact the specific user by the person or the group of persons; and blocking electronic communications between devices logically associated with the person or the group of persons and the specific user.

A system to provide prioritized availability information may be summarized as a including at least one processor; at least one processor-readable storage device that stores instructions executable by the at least one processor that cause the at least one processor to provide prioritized availability information, by: receiving at least one user input via a user interface; mapping a plurality of activities to a number of availability statuses based on the received user input, at least some of the activities associated with specific applications executable on a computing system; at least partially automatically identifying a currently active activity associated with a specific user; and providing an indication indicative of an availability status for the specific user based at least in part on the identified currently active activity associated with the specific user and based at least in part on the availability status for the activity specified for the currently active activity status by the mapping. The instructions may cause the at least one processor to map the plurality of activities to the number of availability statuses by mapping a first computer-executable application to a first availability status and mapping a second computer-executable application executable on a computer to a second availability status. The instructions may cause the at least one processor to map the plurality of activities to the number of availability statuses by mapping at least one of a telephone usage activity or a voicemail usage activity to at least one of the availability statuses. The instructions may cause the at least one processor to at least partially automatically identify the currently active activity associated with the specific user by automatically identifying any specific applications currently executing on a computer logically associated with the specific user. The instructions may cause the at least one processor to at least partially automatically identify the currently active activity associated with the specific user by automatically identifying a specific application associated with a currently selected window on a computer logically associated with the specific user. The instructions may cause the at least one processor to at least partially automatically identify the currently active activity associated with the specific user by automatically determining which application executing on a computer logically associated with the specific user received a most recent input. The instructions may cause the at least one processor to at least partially automatically identify the currently active activity associated with the specific user by: automatically determining a duration since a most recent user input to at least one application executing on a computer logically associated with the specific user; computationally comparing the determined duration to a threshold duration; and identifying the at least one application executing on the computer logically associated with the specific user as not currently active if the determined duration is greater than the threshold duration; and identifying the at least one application executing on the computer logically associated with the specific user as currently active if the determined duration is not than the threshold duration.

The system may further include an indicator positioned at least proximate a location of the specific user. The instructions may cause the at least one processor to provide the indication indicative of the availability status for the specific user by transmitting a signal to a device from which an inquiry regarding a current available status for the specific user originated.

The system may further include a module; at least one user operable input device carried by the module selectively operable to provide a user input indicative of an availability status; at least one communications port carried by the module, the port to provide communicative coupling with at least one peripheral electronic device; a knob selectively operable to control at least one aspect of the at least one peripheral electronic device.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a desktop including a computing system, a telephone and an availability indication unit, according to one illustrated embodiment.

FIG. 2 is a front elevational view of a doorway, with a closed door and an availability indication unit, according to one illustrated embodiment.

FIG. 3 is a schematic diagram of a control subsystem such as a client or user computing system, according to one illustrated embodiment.

FIG. 4 is a flow diagram of a method of operating activity based availability indication system, according to one illustrated embodiment.

FIG. 5 is a flow diagram of a method of receiving user input at an activity based availability indication system, according to one illustrated embodiment.

FIG. 6 is a flow diagram of a method of receiving user input at an activity based availability indication system, according to another illustrated embodiment.

FIG. 7 is a flow diagram of a method of mapping activities to availability statuses or levels in an activity based availability indication system, according to one illustrated embodiment.

FIG. 8 is a flow diagram of a method of mapping activities to availability statuses or levels in an activity based availability indication system, according to another illustrated embodiment.

FIG. 9 is a flow diagram of a method of mapping activities to availability statuses or levels in an activity based availability indication system, according to another illustrated embodiment.

FIG. 10 is a flow diagram of a method of mapping activities to availability statuses or levels in an activity based availability indication system, according to another illustrated embodiment.

FIG. 11 is a flow diagram of a method of mapping activities to availability statuses or levels in an activity based availability indication system, according to another illustrated embodiment.

FIG. 12 is a flow diagram of a method of at least partially automatically identifying a currently active activity associated with a specific user in an activity based availability indication system, according to one illustrated embodiment.

FIG. 13 is a flow diagram of a method of at least partially automatically identifying a currently active activity associated with a specific user in an activity based availability indication system, according to another illustrated embodiment.

FIG. 14 is a flow diagram of a method of at least partially automatically identifying a currently active activity associated with a specific user in an activity based availability indication system, according to another illustrated embodiment.

FIG. 15 is a flow diagram of a method of at least partially automatically identifying a currently active activity associated with a specific user in an activity based availability indication system, according to another illustrated embodiment.

FIG. 16 is a flow diagram of a method of at least partially automatically identifying a currently active activity associated with a specific user in an activity based availability indication system, according to another illustrated embodiment.

FIG. 17 is a flow diagram of a method of providing an availability indication in an activity based availability indication system, according to another illustrated embodiment.

FIG. 18 is a flow diagram of a method of providing an availability indication in an activity based availability indication system, according to another illustrated embodiment.

FIG. 19 is a flow diagram of a method of receiving user input in an activity based availability indication system, according to another illustrated embodiment.

FIG. 20 is a flow diagram of a method of controlling electronic communications based on a determined current activity, according to one illustrated embodiment.

FIG. 21 is a flow diagram of a method of controlling electronic communications based on a determined current activity in an activity based availability indication system, according to another illustrated embodiment.

FIG. 22 is a flow diagram of a method of receiving user input in an activity based availability indication system, according to another illustrated embodiment.

FIG. 23 is a flow diagram of a method of receiving user input in an activity based availability indication system, according to another illustrated embodiment.

FIG. 24 is a flow diagram of a method of tracking usage in an activity based availability indication system, according to one illustrated embodiment.

FIG. 25 is a flow diagram of a method of providing an indication of availability in an activity based availability indication system, according to another illustrated embodiment.

FIG. 26 is a flow diagram of a method of suppressing electronic communications in an activity based availability indication system, according to one illustrated embodiment.

FIG. 27 is a schematic diagram of an architecture of an activity based availability indication system, according to one illustrated embodiment.

FIG. 28 is a schematic diagram of a corporate high level architecture of an activity based availability indication system, according to one illustrated embodiment.

FIG. 29 is a schematic diagram of a high level architecture of a user client application operating on a computer, according to one illustrated embodiment.

FIG. 30 is a schematic diagram of a standalone corporate architecture, according to one illustrated embodiment.

FIG. 31 is a schematic diagram of a standalone corporate architecture integrated with corporate directory services, according to one illustrated embodiment.

FIG. 32 is a schematic diagram of an integrated corporate architecture, according to one illustrated embodiment.

FIG. 33 is a schematic diagram of a hosted architecture, according to one illustrated embodiment.

FIG. 34 is a schematic diagram of a project/task time recording system, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with servers, networks, computers, memory devices and/or displays have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The apparatus and methods illustrated and described herein are not limited to particular user (e.g., worker) in a particular environment (e.g., work). It should be understood that the user may represent any person that needs/wants to manage his/her time, avoid interruption and increase productivity. The apparatus and methods described herein may be used to facilitate time management of a machine that interruption may damage or reduce its productivity, throughput or efficiency.

The approaches described herein may provide solutions for numerous numbers of workers who perform their tasks while using computers or other electronic equipment. The approaches described herein typically includes part or all of the following components: a) a client software package executing on a user's computer; b) a software package executing on a server that communicatively couples various user computers; c) an optional desktop selector that a user may employ to change current activity or availability status or level; d) one or more availability indicator units which may be positioned proximate a door or a desk, for example, and which can indicate at least two different availability statuses; e) an optional interface to one or more telephone lines to monitor and/or control some aspect of incoming calls; and/or f) an optional interface to a cell phone to monitor and/or control some aspect of incoming calls.

The software client executing on the user's computers is capable of various functions, specified below. For example, in everyday work, workers typically use different software applications for their daily tasks. For example; software engineers perform their tasks using compliers and code editing tools, mechanical engineers perform their tasks using design and drawing software applications (e.g., SOLIDWORKS®, AUTOCAD®) or analysis applications (e.g., MATLAB®), project managers perform their tasks using project management software (e.g., MS-PROJECT®), accountants perform their tasks using spreadsheet software, accounting software (e.g., QUICKBOOKS®) or tax preparation software, and lawyers perform their tasks using a word processor (e.g., MS-WORD®). All of which permit automatically determining a current activity and providing a notification of an availability status or level based on the current activity. Specific embodiments will now be discussed with reference to the Figures.

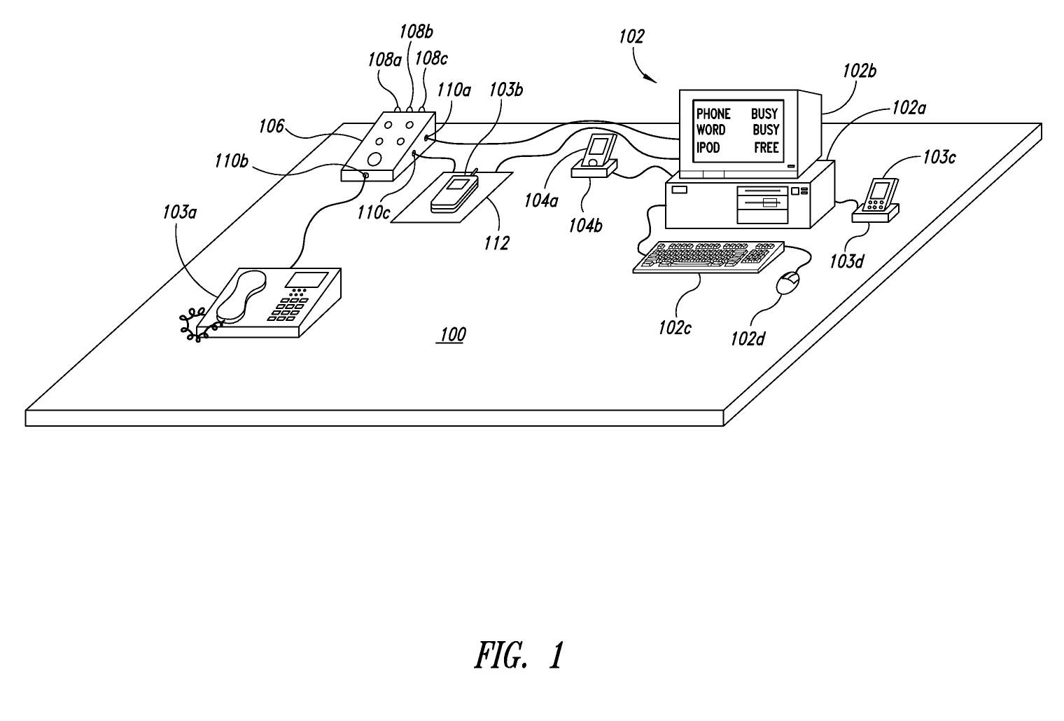

FIG. 1 shows a desktop 100, according to one illustrated embodiment. The desktop 100 may include a variety of different electronic devices. For example, a computing system 102 may be positioned on or proximate the desktop 100. The computing system 102 may include a computer 102a, monitor 102b, keyboard 102c, and a pointer device such as a mouse or trackball 102d all communicatively coupled via one or more cables or wireless interfaces (e.g., BLUETOOTH® compliant). One or more communications devices may be positioned on or proximate the desktop 100, for example a landline phone 103a, cellular phone 103b, and/or personal digital assistant (PDA) 103c such as a BLACKBERRY® device, TREO® device, PHONED device, or other wireless Internet and/or Web enabled communications devices. The personal digital assistant 103c may be communicatively coupled to the computer 102a, for instance via a dock 103d and one or more cables or wireless interfaces (e.g., BLUETOOTH® compliant). Additionally, one or more personal entertainment devices 104a may be positioned on or proximate the desktop 100, for example an IPOD® or other M3P digital music players. The personal entertainment devices 104a may be communicatively coupled to the computer 102a, for instance via a dock 104b and one or more cables or wireless interfaces (e.g., BLUETOOTH® compliant). Other electronic devices may be positioned on or proximate the desktop 100.

An availability indication unit 106 may be positioned on or proximate the desktop 100. The availability indication unit 106 is configured to provide an indication of an availability status or level of a user who uses the computing system 102 and/or electronics such as the communications devices 103a-103c (collectively 103) and/or entertainment devices 104a on or proximate the desktop 100. While the use of the term level is used, such does not necessarily denote any hierarchical ordering.

In particular, the availability indication unit 106 may include one or more visual indicators 108a-108c, selectively operable to provide a visual indication of availability status or level. For instance, the visual indicators 108a-108c may take the form of one or more lights, for instance three light emitting diodes (LEDs), each of a respective color. For example a red LED 108a may indicate that no interruptions are permitted, while a green LED 108b indicates that interruptions are permitted and a yellow LED 108c indicates that only important interrupts are permitted. Fewer or greater number of visual indicators may be employed, which may, or may not employ fewer or greater number of colors, or may not employ colors at all. Alternatively, or additionally, an availability message may be displayed, for example via a visual display, for instance a liquid crystal display (LCD) screen. The availability message may for example state the availability status or level in broad terms (e.g., Do Not Disturb, Available) and/or may state the availability status or level in more refined terms (e.g., Available for Important Questions; Available to Discuss XYZ Project Only).

The availability indication unit 106 may be part of a desktop selector, and thus may include one or more user operable input devices, for example keys, switches (e.g., rocker, toggle), user selectable icons, knobs, buttons, pointer devices, etc. Such may allow the user to manually set a current activity and/or current availability status or level. Such may additionally or alternatively allow the user to configure activities, availability statuses, suppression of electron communications, and/or relationships between the same. Such may also additionally or alternatively allow the user to adjust a volume of the computing system or electronic devices.

The availability indication unit 106 may include one or more communications ports 110a-110c (collectively 110) that can provide communications with other devices. For example, a communications port 110a may provide one- or two-way communications with the computing system 102. A communications port 110b may provide one- or two-way communications with other electronic devices, for instance the landline telephone 103a. A communications port 110c may provide one- or two-way communications with one or more sensors 112. Thus, the availability indication unit 106 may act as an intermediary, coupling various electronic devices 103a and sensors 112 to the computing system 102 which may execute logic or instructions that implement the various availability related and other functions discussed herein.

One or more sensors 112 (only one illustrated) positioned on or proximate the desktop 100. The sensors 112 may allow monitoring of a large variety of activities that do not involve the computing system 102. For instance, the sensors 112 may allow monitoring activity related to usage of a cellular phone 112. Sensors 112 may take a variety of forms, for instance optical sensors which can detect presence/absence, or that can acquire images (e.g., still, moving, analog, digital images). Also for instances, sensors 112 may sense or detect sound or sample sound, thus enabling detection of conversations when a selected user is in a meeting or conducting a phone conference. Also for instances, sensors 112 may sense or detect mass or magnetic fields, thus enabling detection of specific devices or presence of a body in a chair. Also for instances, sensors 112 may sense or detect magnetic fields, thus enabling detection of specific devices. Also for instances, sensors 112 may sense or detect heat, thus enabling the detection of one or more bodies in an office or a chair. Also for instances, sensors 112 may sense or detect motion, thus enabling detection of specific devices or presence of a body in an office or a chair. Any variety of other types of sensors may be employed. For instance, an electro-optical isolated sensor may determine when an analog phone is off hook.

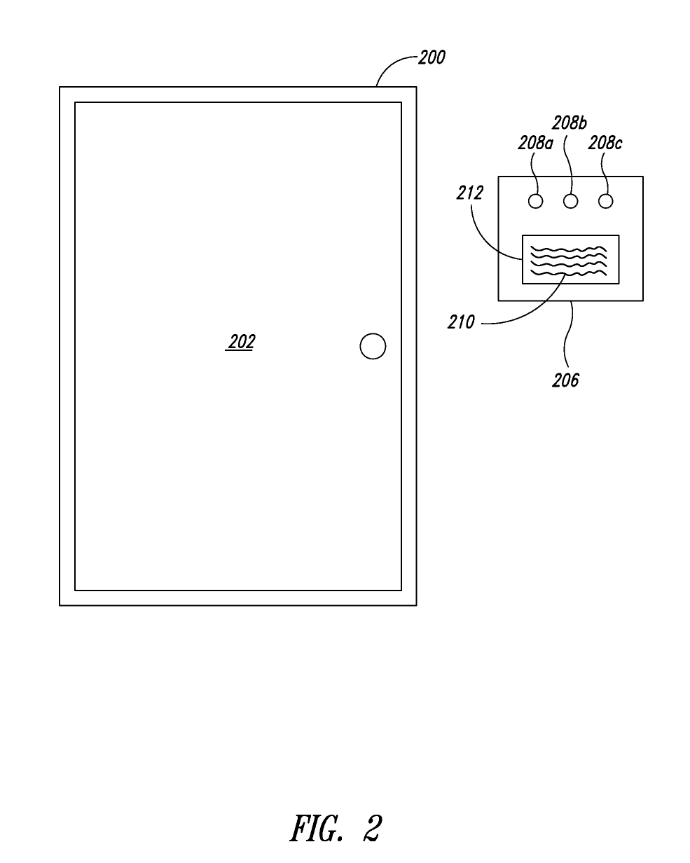

FIG. 2 shows a doorway 200, with a closed door 202 and an availability indication unit 206 positioned outside the doorway 200, according to one illustrated embodiment.

The availability indication unit 206 may be communicatively coupled to the computing system 102 (FIG. 1), for example via wireless transmitters, receivers or transceivers, or via one or more cables or other wired communications channels.

The availability indication unit 206 may include one or more visual indicators 208a-208c, selectively operable to provide a visual indication of availability status or level. For instance, the visual indicators 208a-208c may take the form of one or more lights, for instance three light emitting diodes (LEDs), each of a respective color. For example a red LED 208a may indicate that no interruptions are permitted, while a green LED 208b indicates that interruptions are permitted and a yellow LED 208c indicates that only important interrupts are permitted. Fewer or greater number of visual indicators may be employed, which may, or may not employ fewer or greater number of colors, or may not employ colors at all. Alternatively, or additionally, an availability message 210 may be displayed, for example via a visual display 212, for instance a liquid crystal display (LCD) screen. The availability message 210 may for example state the availability status or level in broad terms (e.g., Do Not Disturb, Available) and/or may state the availability status or level in more refined terms (e.g., Available for Important Questions; Available to Discuss XYZ Project Only). The availability indication unit 206 may include a solenoid activated indicator. While illustrated mounted proximate a doorway 200, the availability indication unit 206 could be mounted in other places visible to coworkers, for instance exterior of cubicle, table, etc.

FIG. 3 and the following discussion provide a brief, general description of a suitable control subsystem 304 in which the various illustrated embodiments can be implemented. The control subsystem 304 may, for example, implement the computing system 102 (FIG. 1). Alternatively, one control subsystem 304 may implement one or more of the availability indicators 106, 206.

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The control subsystem 304 may take the form of a conventional PC, which includes a processing unit 306, a system memory 308 and a system bus 310 that couples various system components including the system memory 308 to the processing unit 306. The control system 304 will at times be referred to in the singular herein, but this is not intended to limit the embodiments to a single system, since in certain embodiments, there will be more than one system or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 306 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 3 are of conventional design. As a result, such blocks need not be described in further detail herein, as they will be understood by those skilled in the relevant art.

The system bus 310 can employ any known bus structures or architectures, including a memory bus with memory controller, a peripheral bus, and a local bus. The system memory 308 includes read-only memory (“ROM”) 312 and random access memory (“RAM”) 314. A basic input/output system (“BIOS”) 316, which can form part of the ROM 312, contains basic routines that help transfer information between elements within the control subsystem 304, such as during start-up. Some embodiments may employ separate buses for data, instructions and power.

The control subsystem 304 also includes a hard disk drive 318 for reading from and writing to a hard disk 320, and an optical disk drive 322 and a magnetic disk drive 324 for reading from and writing to removable optical disks 326 and magnetic disks 328, respectively. The optical disk 326 can be a CD or a DVD, while the magnetic disk 328 can be a magnetic floppy disk or diskette. The hard disk drive 318, optical disk drive 322 and magnetic disk drive 324 communicate with the processing unit 306 via the system bus 310. The hard disk drive 318, optical disk drive 322 and magnetic disk drive 324 may include interfaces or controllers (not shown) coupled between such drives and the system bus 310, as is known by those skilled in the relevant art. The drives 318, 322, 324, and their associated computer-readable media 320, 326, 328, provide nonvolatile storage of computer-readable instructions, data structures, program modules and other data for the control subsystem 304. Although the depicted control subsystem 304 employs hard disk 320, optical disk 326 and magnetic disk 328, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 308, such as an operating system 330, one or more application programs 332, other programs or modules 334, drivers 336 and program data 338.

The application programs 332 may, for example, include availability configuration logic 332a, activity determination logic 332b, availability indication logic 332c, and/or communications control logic 332d. The logic 332a-332d may, for example, be stored as one or more executable instructions.

As discussed in more detail below, the availability configuration logic 332a may include logic or instructions to implement a user interface that allows a user to configure the system by, for example, defining relationships between activities and availability status or levels, define new activities, define new availability status or levels or delete existing ones. Thus, for example, the availability configuration logic 332a may implement a graphical user interface that includes user selectable icons that allow a user to define relationships, create or delete activities and/or create or delete availability status or levels. Such may also allow users to define relationships between various forms of electronic communications (e.g., landline phone 103a, cellular phone 103b, wireless PDAs 103c, electronic mail, text messaging, instant messaging, short message service or SMS, facsimiles, voice over Internet Protocol or VIOP, etc.) and activities or availability status or levels. For instance, such may allow a specific user to identify particular types of electronic communications that will be suppressed (e.g., disable user alerts regarding receipt of new electronic communications or block electronic communications completely) when the user is engaged in certain activities.

The activity determination logic 332b may include logic or instructions that monitor or otherwise determine in which activity the specific user is currently engaged. Monitoring or determining a current activity may include monitoring applications executing on the computer 102a. Monitoring applications may include determining which applications are executing, determining which application or window is currently selected or active, and/or determining how recently input has been received in each application. Monitoring or determining a current activity may also include monitoring electronic devices that are communicatively coupled to the computing system 102, for instance personal digital assistants 103c and/or entertainment devices 104a. Monitoring these electronic devices 103c, 104a may include monitoring applications executing on the computer 102a that are associated with the device 103c, 104a and/or detecting a presence or absence of the device 103c, 104a in an associated dock 103d, 104d, respectively. Monitoring or determining a current activity may also include monitoring electronic devices that are communicatively coupled to the computing system 102 via the availability indication unit 106, for instance a landline phone 103a. Such may include monitoring or determining a status with respect to outgoing or incoming calls, whether the handset is “on the hook”, whether a speaker phone option has been selected, and/or whether a do not disturb feature has been activated. Monitoring or determining a current activity may further include monitoring electronic devices that are not communicatively coupled to the computing system 102, for example monitoring via one or more sensors 112. For example, a sensor 112 may be used to detect a characteristic related to the cellular phone 103b, for instance presence or absence of the cellular phone 103b from a particular position on the desktop 100.

The availability indication logic 332d may include logic or instructions to provide indications of availability based on a determined current activity and a relationship or mapping between activities and availability status or levels. For example, the availability indication logic 332d may determine the appropriate availability status or level based on the determined current activity. The availability indication logic 332d may control one or more availability indication units 106, 206 accordingly. For instance, the availability indication logic 332d may send a signal to cause the availability indication units 106, 206 to display an appropriate visual availability indication (e.g., red, green, yellow, general message, specific message, etc.). Also for example, the availability indication logic 332d may respond to inquires regarding the availability of a specific individual, for instance transmitting (e.g., wired or wirelessly) an availability message to an inquiring device that has inquired about the availability of a specific user. The availability indication logic 332d may transmit an availability message via a network, such as a computer network or communications network (e.g., POTS or cellular networks). The availability logic may employ logical associations to connect a specific user with a computing system 102, or other electronic devices 103a, 103c, 104a, 112.

As discussed in detail below, the communications control logic 332d may include logic or instructions to suppress communications based on type and/or source and based on a determined current activity. For example, the communications control logic 332d may prevent incoming communications and/or may prevent alerts regarding incoming communications when the user is perceived as being engaged in certain activities and/or certain availability status or levels are indicated. For instance, all forms of electronic communications may be permitted when the availability status or level is available (or some similar denomination), but all forms of electronic communications may be suppressed when the availability status or level is do not disturb (or some similar denomination). Different availability status or levels may allow some forms of electronic communications (e.g., telephones), which suppressing other forms of electronic communications (e.g., electronic mail or instant messaging). Such may be user configured, or may be configured by an authorized person for a group of users. The communications control logic 332d may suppress some forms of communications by interacting with other programs or applications executing on the computer 102a, for example automatically modifying an alert setting in an email program or electronic calendar. The communications control logic 332d may suppress some forms of communications by interacting with other programs or applications executing on an electronic device, for instance automatically controlling a do not disturb feature on the landline phone 103a. The communications control logic 332d may suppress some forms of communications by actively interfering with some electronic equipment, for instance jamming communications with cellular phone 112.

The system memory 308 may also include communications programs 340, for example a server and/or a Web client or browser for permitting the control subsystem 304 to access and exchange data with other systems such as user computing systems 122, Web sites on the Internet, corporate intranets, or other networks as described below. The communications programs 340 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 3 as being stored in the system memory 308, the operating system 330, application programs 332, other programs/modules 334, drivers 336, program data 338 and server and/or browser 340 can be stored on the hard disk 320 of the hard disk drive 318, the optical disk 326 of the optical disk drive 322 and/or the magnetic disk 328 of the magnetic disk drive 324. A user can enter commands and information into the control subsystem 304 through input devices such as a touch screen or keyboard 342 and/or a pointing device such as a mouse 344. Other input devices can include a microphone, joystick, game pad, tablet, scanner, biometric scanning device, etc. These and other input devices are connected to the processing unit 306 through an interface 346 such as a universal serial bus (“USB”) interface that couples to the system bus 310, although other interfaces such as a parallel port, a game port or a wireless interface or a serial port may be used. A monitor 348 or other display device is coupled to the system bus 310 via a video interface 350, such as a video adapter. Although not shown, the control subsystem 304 can include other output devices, such as speakers, printers, etc.

The control subsystem 304 may operate in a networked environment using one or more of the logical connections to communicate with one or more remote computers, servers and/or devices via one or more communications channels, for example, one or more networks 314a, 314b. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the control subsystem 304 may include a modem 354 for establishing communications over the WAN, for instance the Internet 314a. The modem 354 is shown in FIG. 3 as communicatively linked between the interface 346 and the Internet 314a. Additionally or alternatively, another device, such as a network port 356, that is communicatively linked to the system bus 310, may be used for establishing communications over the Internet 314a. Further, one or more network interfaces 352a-352c, that are communicatively linked to the system bus 310, may be used for establishing communications over a LAN 314b. In particular, a sensor interface 352a may provide communications with a sensor subsystem (e.g., sensor subsystem 112 of FIG. 1). An electronic device interface 352b may provide communications with one or more electronic devices (e.g., PDA dock 103d, entertainment device dock 104b of FIG. 1). An availability indication unit interface 352c may provide communications with one or more availability indication units 106, 206 (FIGS. 1 and 2).

In a networked environment, program modules, application programs, or data, or portions thereof, can be stored in a server computing system (not shown). Those skilled in the relevant art will recognize that the network connections shown in FIG. 3 are only some examples of ways of establishing communications between computers, and other connections may be used, including wirelessly.

For convenience, the processing unit 306, system memory 308, network port 356 and interfaces 346, 352a-352c are illustrated as communicatively coupled to each other via the system bus 310, thereby providing connectivity between the above-described components. In alternative embodiments of the control subsystem 304, the above-described components may be communicatively coupled in a different manner than illustrated in FIG. 3. For example, one or more of the above-described components may be directly coupled to other components, or may be coupled to each other, via intermediary components (not shown). In some embodiments, system bus 310 is omitted and the components are coupled directly to each other using suitable connections.

Operation of an exemplary embodiment of the activity based availability indication system will now be described in greater detail. While reference is made throughout the following discuss to the embodiment of FIGS. 1 and 2, the methods may be employed with other embodiments, with or without modification.

FIG. 4 shows a method 400 of operating activity based availability indication system, according to one illustrated embodiment. The method 400 may be useful reducing interruptions to specific users and/or to prevent others from wasting time seeking a person when that person currently is not available.

At 402, the activity based availability indication system receives at least one user input via at least one user interface. For instance, input may be received via one or more user input devices of the computing system 102, for instance the keyboard 102c, mouse 102d, or via a touch screen display 102b. The input may for example identify a relationship or mapping between an activity and an availability status or level. The input may additionally or alternatively define a new activity and/or availability status or level or delete existing activities or availability statuses or levels. Such may be accomplished using a graphical user interface and a number of preconfigured or predefined activities and/or availability statuses or levels.

At 404, the activity based availability indication system maps a plurality of activities to a number of availability statues or levels based on the received user input, at least some of the activities associated with specific applications executable on a computing system. For example, the availability configuration logic 332a may create or update appropriate records or pointers or a lookup table to define relationships between activities and availability statuses or levels. For instance, phone usage activities may be related with a do not disturb availability status or level. One type of software application (e.g., electronic mail or “email”) may be related with an available availability status or level, while another type of software application (e.g., finite element analysis program or word processor) may be related with a disturb only if important or only if related to a given project availability status or level.

At 406, the activity based availability indication system at least partially automatically identifies a currently active activity associated with a specific user. As previously noted, the activity determination logic 332b may monitor or determine which applications are open or executing on a computing system 102, or which window is open or active, or which application has had recent user input and whether that user input is within some threshold duration. Also as previously noted the activity determination logic 332b may monitor electronic devices 103a, 103c, 104a, communicatively coupled directly or indirectly to the computing system 102, or may monitor one or more sensors 112.

At 408, the activity based availability indication system provides an indication indicative of an availability status or level for the specific user based at least in part on the identified currently active activity associated with the specific user and based at least in part on the availability status or level for the activity specified for the currently active activity status or level by the mapping. As previously noted, the availability indication logic 332c may transmit signals to one or more availability indication units 106, 206 (FIGS. 1, 2) or send an availability message to an inquiring device (e.g., another computer, wireless communications device, etc.)

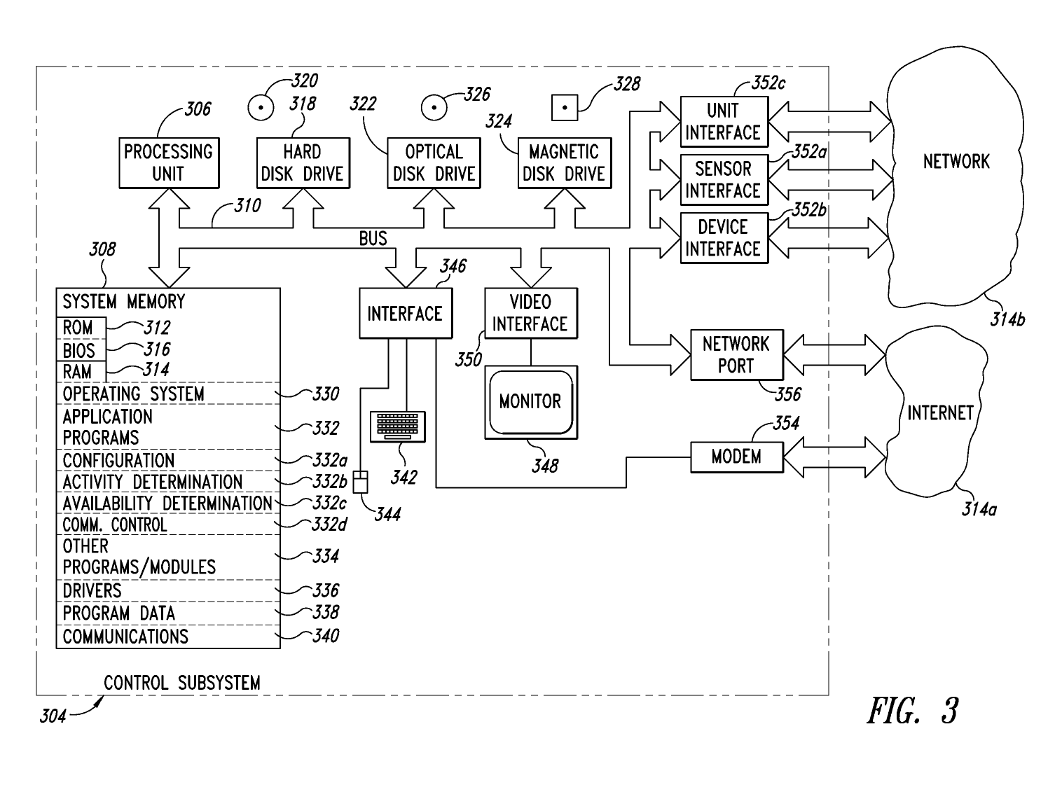

FIG. 5 shows a method 500 of receiving user input at an activity based availability indication system, according to one illustrated embodiment. The method 400 may be useful in the receiving user input 402 of the method 400 (FIG. 4).

At 502, at least one user input is received from a computer logically associated with the specified user. Such may allow a user to define their own relationships or mapping between various activities and availability statuses or levels and/or to define relationships or mapping between various forms of electronic communications and either activities or availability statuses or levels or both. As noted above, the user may interact with a user interface to define such.

FIG. 6 shows a method 600 of receiving user input at an activity based availability indication system, according to another illustrated embodiment. The method 600 may be useful in the receiving user input 402 of the method 400 (FIG. 4).

At 602, at least one of user input is received from a computer that is not logically associated with the specified user. Thus, for example, an authorized person such as systems manager or coordinator or network administrator, may configure the relationships or mapping between various activities and availability statuses or levels. Such may be done to define a default set of relationships or mapping, or to define a set of relationships or mapping for a group, for example a work group or project team.

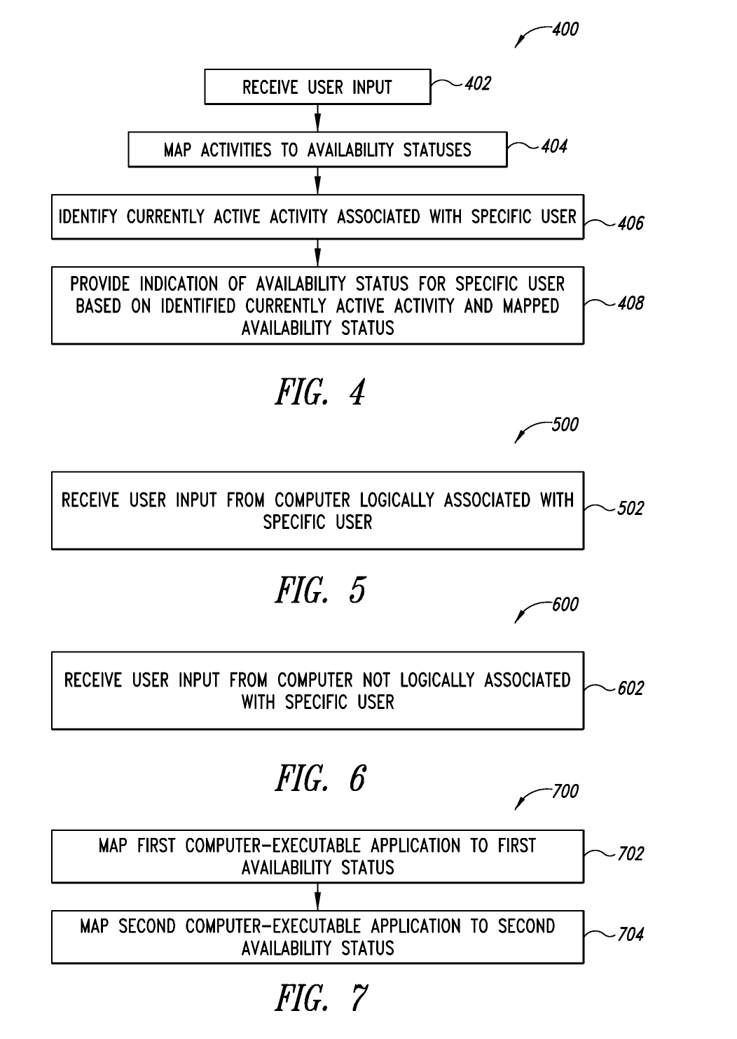

FIG. 7 shows a method 700 of mapping activities to availability statuses or levels in an activity based availability indication system, according to one illustrated embodiment. The method 700 may be useful in the mapping 404 of the method 400 (FIG. 4).

At 702, the availability configuration logic 332a of the activity based availability indication system maps a first computer-executable application to a first availability status or level. At 704, the availability configuration logic 332a maps a second computer-executable application to a second availability status or level. The mapping may, for example, include creating or updating records and/or pointers in a data structure or updating a lookup table or the like. Hence, applications such as spreadsheet applications, word processing applications, photo manipulation applications, computer aided design applications, computer aided manufacturing applications, finite element analysis applications, etc., may all be related to one or more availability statuses or levels.

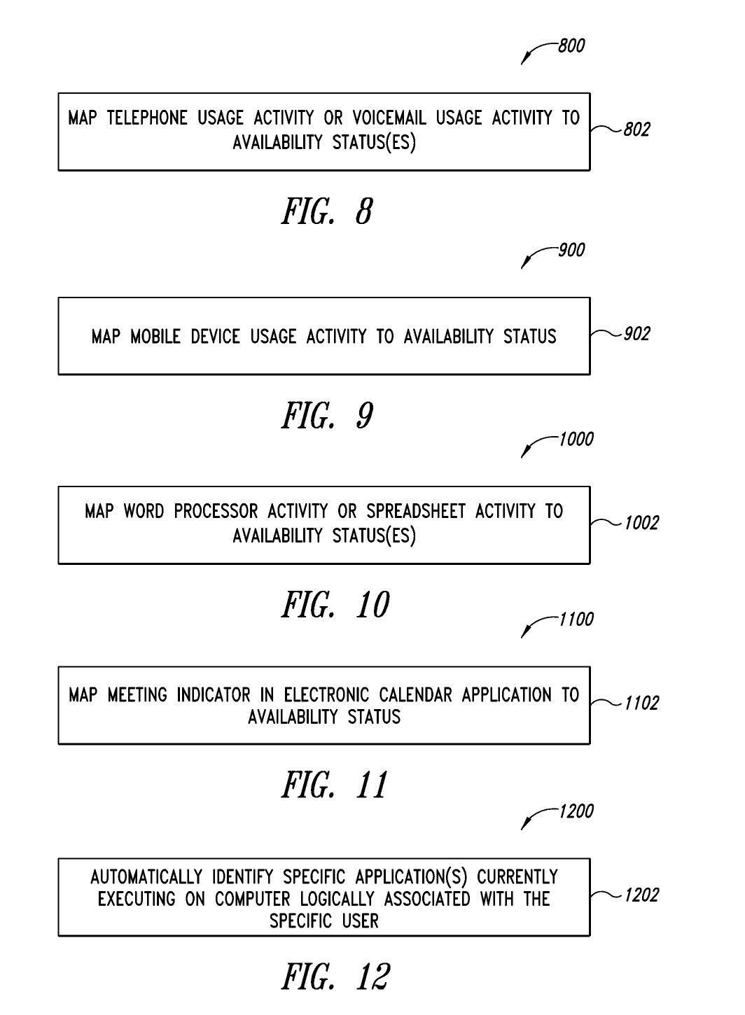

FIG. 8 shows a method 800 of mapping activities to availability statuses or levels in an activity based availability indication system, according to another illustrated embodiment. The method 800 may be useful in the mapping 404 of the method 400 (FIG. 4).

At 802, the availability configuration logic 332a of the activity based availability indication system maps at least one of a telephone usage activity or a voicemail usage activity to at least one of the availability statuses or levels. The mapping may, for example, include creating or updating records and/or pointers in a data structure or updating a lookup table or the like. Hence, activities such as phone usage or voicemail usage may be related to one or more availability statuses or levels.

FIG. 9 shows a method 900 of mapping activities to availability statuses or levels in an activity based availability indication system, according to another illustrated embodiment. The method 900 may be useful in the mapping 404 of the method 400 (FIG. 4).

At 902, the availability configuration logic 332a of the activity based availability indication system maps at least one of a mobile device usage activity to one of the availability statuses or levels. The mapping may, for example, include creating or updating records and/or pointers in a data structure or updating a lookup table or the like. Hence, activities such as use of a particular mobile device versus other mobile devices (e.g., cellular phone versus PDA) and/or use of a specific function (e.g., phone, emailing, texting, short message service, Internet access or Web access) may be related to one or more availability statuses or levels.

FIG. 10 shows a method 1000 of mapping activities to availability statuses or levels in an activity based availability indication system, according to another illustrated embodiment. The method 1000 may be useful in the mapping 404 of the method 400 (FIG. 4).

At 1002, the availability configuration logic 332a of the activity based availability indication system maps at least one of a word processor activity or a spreadsheet activity to at least one of the availability statuses or levels. The mapping may, for example, include creating or updating records and/or pointers in a data structure or updating a lookup table or the like. Hence, activities such as use of a particular software application or even particular functions (e.g., cutting and pasting versus applying a filter in a photo editing application) within a software application may be related to one or more availability statuses or levels.

FIG. 11 shows a method 1100 of mapping activities to availability statuses or levels in an activity based availability indication system, according to another illustrated embodiment. The method 1100 may be useful in the mapping 404 of the method 400 (FIG. 4).

At 1102, the availability configuration logic 332a of the activity based availability indication system maps a meeting indicator in an electronic calendar application to one of the availability statuses or levels. Hence, activities such as scheduled meetings and phone conferences may be related to one or more availability statuses or levels, for instance do not disturb or a similar level during important meeting or phone conferences.

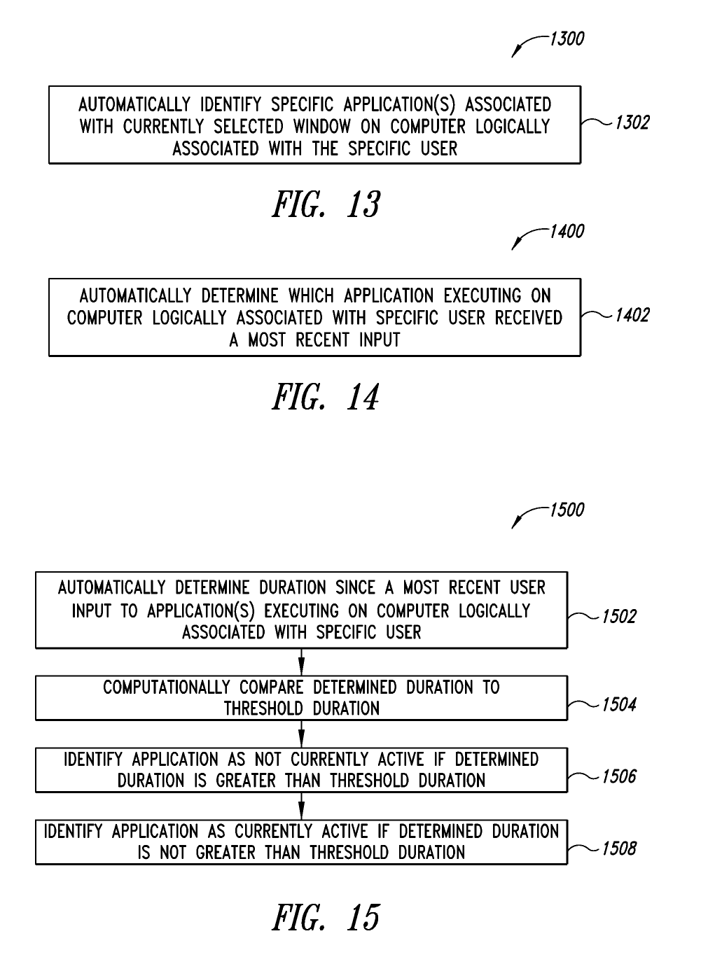

FIG. 12 shows a method 1200 of at least partially automatically identifying a currently active activity associated with a specific user in an activity based availability indication system, according to another illustrated embodiment. The method 1200 may be useful in the identifying a currently active activity 406 of the method 400 (FIG. 4).

At 1202, the activity determination logic 332b of the activity based availability indication system automatically identifies any specific applications currently executing on a computer logically associated with the specific user. The activity determination logic 332b may be executing on the computing system 102, hence can access the operating system to determine which applications are currently executing or open. Alternatively, the activity determination logic 332b may make a remote inquire to the computing system logically associated with the selected user. For instance, the activity determination logic 332b may query for a computing system on which a user with a given identifier logically associated with the selected user is working.

FIG. 13 shows a method 1300 of at least partially automatically identifying a currently active activity associated with a specific user in an activity based availability indication system, according to another illustrated embodiment. The method 1300 may be useful in the identifying a currently active activity 406 of the method 400 (FIG. 4).

At 1302, the activity determination logic 332b of the activity based availability indication system automatically identifies a specific application associated with a currently selected window on a computer logically associated with the specific user. The activity determination logic 332b may be executing on the computing system 102, hence can access the operating system to determine which windows is currently selected. Alternatively, the activity determination logic 332b may make a remote inquire to the computing system logically associated with the selected user. For instance, the activity determination logic 332b may query for a computing system on which a user with a given identifier logically associated with the selected user is working.

FIG. 14 shows a method 1400 of at least partially automatically identifying a currently active activity associated with a specific user in an activity based availability indication system, according to another illustrated embodiment. The method 1400 may be useful in the identifying a currently active activity 406 of the method 400 (FIG. 4).

At 1402, the activity determination logic 332b of the activity based availability indication system automatically determines which application executing on a computer logically associated with the specific user received a most recent input. The activity determination logic 332b may be executing on the computing system 102, hence can access the operating system to determine which application has received the most recent user input. Alternatively, the activity determination logic 332b may make a remote inquire to the computing system logically associated with the selected user. For instance, the activity determination logic 332b may query for a computing system on which a user with a given identifier logically associated with the selected user is working.

FIG. 15 shows a method 1500 of at least partially automatically identifying a currently active activity associated with a specific user in an activity based availability indication system, according to another illustrated embodiment. The method 1500 may be useful in the identifying a currently active activity 406 of the method 400 (FIG. 4).

At 1502, the activity determination logic 332b of the activity based availability indication system automatically determines a duration since a most recent user input to at least one application executing on a computer logically associated with the specific user. The activity determination logic 332b may be executing on the computing system 102, hence can access the operating system to determine the duration since a last input to an executing application. The activity determination logic 332b may run a clock or timer to determine durations between inputs to one or more applications executing on the computing system 102. Alternatively, the activity determination logic 332b may make a remote inquire to the computing system logically associated with the selected user. For instance, the activity determination logic 332b may query for a computing system on which a user with a given identifier logically associated with the selected user is working.

At 1504, the activity determination logic 332b computationally compares the determined duration to a threshold duration. The threshold duration may be a fixed value, or may be configurable, for instance configurable by the user or an authorized person.

At 1506, the activity determination logic 332b identifies the at least one application executing on the computer logically associated with the specific user as not currently active if the determined duration is greater than the threshold duration. This prevents determining that a particular application is the current activity when a user has turned away from the computing system to work on something else or to leave.

At 1508, the activity determination logic 332b identifies the at least one application executing on the computer logically associated with the specific user as currently active if the determined duration is not greater than the threshold duration.

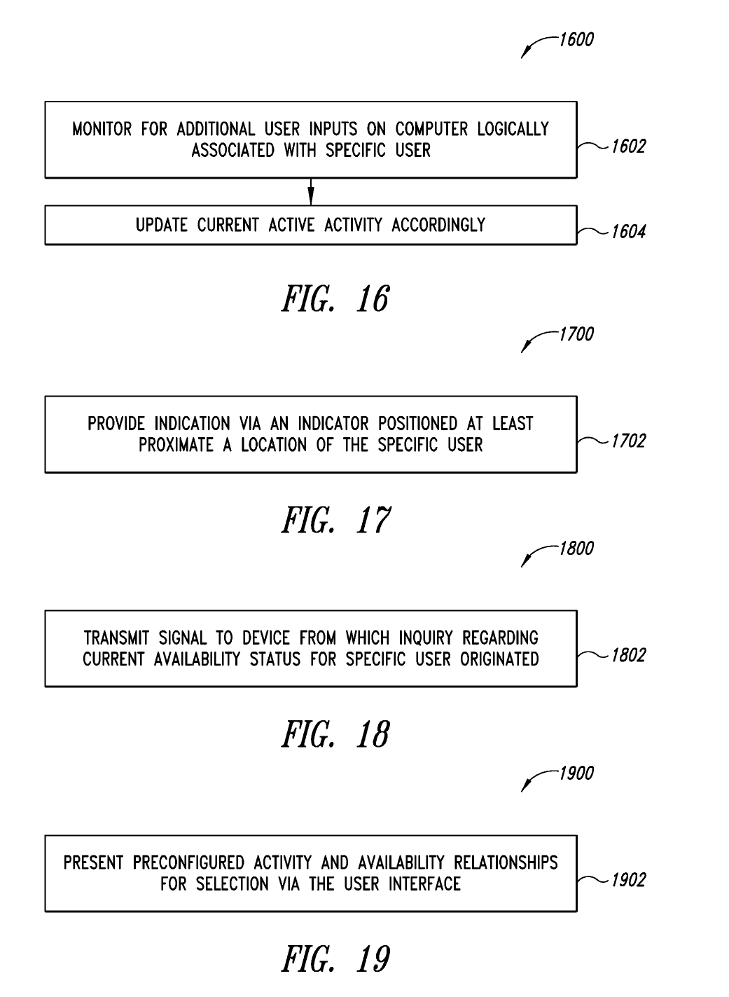

FIG. 16 shows a method 1600 of at least partially automatically identifying a currently active activity associated with a specific user in an activity based availability indication system, according to another illustrated embodiment. The method 1600 may be performed as part of the method 400 (FIG. 4).

At 1602, the activity determination logic 332b of the activity based availability indication system monitors for additional user inputs on a computer logically associated with the specific user received a most recent input. The activity determination logic 332b may be executing on the computing system 102, hence can access the operating system to monitor input. Remote inquiries are also possible where the activity determination logic 332b is executing on a separate computing system.

At 1604, the activity determination logic 332b updates the current active activity accordingly. This allows determination of the most current activity.

FIG. 17 shows a method 1700 of providing an availability indication in an activity based availability indication system, according to another illustrated embodiment. The method 1700 may be useful in providing an indication indicative of an availability level 408 for the specific user of the method 400 (FIG. 4).

At 1702, the availability indication logic 332c of the activity based availability indication system provides an indication via an indicator positioned at least proximate a location of the specific user. The indication may be on a display 102b of the computing system 102 operated by the specific user, thereby providing the specific user feedback to ensure that the proper availability status or level is being indicated.

FIG. 18 shows a method 1800 of providing an availability indication in an activity based availability indication system, according to another illustrated embodiment. The method 1800 may be useful in providing an indication indicative of an availability level 408 for the specific user of the method 400 (FIG. 4).

At 1802, the availability indication logic 332c of the activity based availability indication system transmits a signal to a device from which an inquiry regarding a current available status for the specific user originated. Thus, for example, the indication may be provided at a computer, wireless communications device, telephone, etc. This may allow others to remotely determine whether a specific user is currently available, saving time that would otherwise be spent in phoning the specific user or in physically reaching the specific user's office.

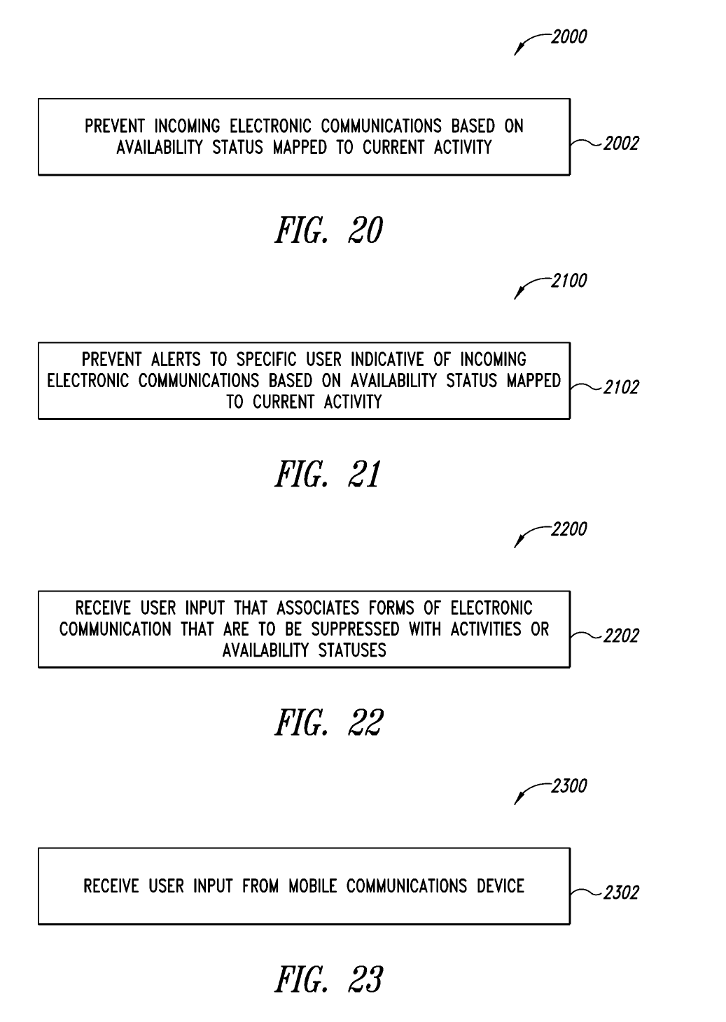

FIG. 19 shows a method 1900 of receiving user input in an activity based availability indication system, according to another illustrated embodiment. The method 1900 may be useful in receiving the input 402 of the method 400 (FIG. 4).

At 1902, the availability configuration logic 332a of the activity based availability indication system presents a plurality of preconfigured activity and availability relationships for selection via the user interface. The presentation may be via a graphical user interface. Such may facilitate the configuration of various activities, availability statuses or levels, suppression of electronic communications and relationships between such by the user or by some authorized persons.

FIG. 20 shows a method 2000 of controlling electronic communications based on a determined current activity, according to one illustrated embodiment. The method 2000 may optionally be performed as an addition to the method 400 (FIG. 4).

At 2000, in response to one of the activities being determined to be the current activity, the communications control logic 332d of the activity based availability indication system prevents incoming electronic communications based on a respective one of the availability statuses or levels mapped to the activity. Such may block the electronic communications to prevent interrupting a selected user when engaged in a current activity that is associated with an availability level such as do not disturb. The communications control logic 332d may adjust functions in email programs or stop execution of email programs, or other programs associated with receipt of electronic correspondence. The communications control logic 332d may cause a landline phone 103a (FIG. 1) to block incoming calls with, or without automatically forwarding the call to voicemail. The communications control logic 332d may interact with a wireless carrier's SS7 system to implement a similar suppression of wireless electronic communications (e.g., calls, SMS, texting, instant messaging, etc.) with, or without, automatic forwarding to voicemail or caching of data. The communications control logic 332d may interact with a wireless communications device 103b, 103c (FIG. 1) via GSM commands to implement a similar suppression of wireless electronic communications (e.g., calls, SMS, texting, instant messaging, etc.) with, or without, automatic forwarding to voicemail or caching of data. Alternatively, the communications control logic 332d may emit electronic interference to jam wireless communications. The communications control logic 332d may even operate a relay or solenoid to physically control electronic devices, for instance a contact relay to disrupt an analog phone line by producing a “busy” state on the phone line.

FIG. 21 shows a method 2100 of controlling electronic communications based on a determined current activity in an activity based availability indication system, according to another illustrated embodiment. The method 2100 may optionally be performed in addition to the method 400 (FIG. 4).

At 2102, in response to one of the activities being determined to be the current activity, the communications control logic 332d of the activity based availability indication system prevents alerts to the specific user that are indicative of incoming electronic communications based on a respective one of the availability statuses or levels mapped to the activity. Such may suppress alerts about the receipt of electronic communications to prevent interrupting a selected user when engaged in a current activity that is associated with an availability level such as do not disturb. The communications control logic 332d may adjust alert functions in email programs or other applications associated with receipt of electronic correspondence, and/or may suppress reminders in electronic calendars. The communications control logic 332d may cause a landline phone to switch to a do not disturb mode, essentially suppressing the alert function (i.e., ring) and automatically forwarding the call to voicemail. The communications control logic 332d may interact with a wireless carrier's SS7 system to implement a similar suppression and forwarding to voicemail for wireless devices.

FIG. 22 shows a method 2200 of receiving user input in an activity based availability indication system, according to another illustrated embodiment. The method 2200 may be useful in the receiving input 402 of the method 400 (FIG. 4).

At 2200, the availability configuration logic 332a of the activity based availability indication system receives at least one user input via the at least one user interface that associates a number of forms of electronic communication that are to be blocked with at least one of the activities or the availability statuses or levels. Thus, a user can define relationships that determine which types of electronic communication will be suppressed (e.g., either blocked and/or alerts turned off) based on activity and/or availability level.

FIG. 23 shows a method 2300 of receiving user input in an activity based availability indication system, according to another illustrated embodiment. The method 2300 may be performed as part of the method 400 (FIG. 4).

At 2302, the availability configuration logic 332a of the activity based availability indication system receives at least some of the user input from a mobile communications device. Thus, a user can remotely define relationships that determine which types of electronic communication will be suppressed (e.g., either blocked and/or alerts turned off) based on activity and/or availability level. Alternatively, or additionally, an authorized person such as a systems manager or coordinator or network administrator can define the same relationships.

FIG. 24 shows a method 2400 of tracking usage in an activity based availability indication system, according to one illustrated embodiment. The method 2400 may be performed as an addition to the method 400 (FIG. 4).

At 2402, the activity based availability indication system tracks time, for example by application and file name. The activity determination logic 332b may be executing on the computing system 102, hence can access the operating system to monitor use of various applications and files. Remote inquiries are also possible where the activity determination logic 332b is executing on a separate computing system. Since many applications will be associated with client or matter specific files, such tracking may be easily assigned to appropriate projects, jobs or tasks. Such information may be used for billing based on project task lists or for productivity tracking. Such information may additionally or alternatively be useful in assessing employee productivity.

FIG. 25 shows a method 2500 of providing an indication of availability in an activity based availability indication system, according to another illustrated embodiment. The method 2500 may be performed as part of the method 400 (FIG. 4).

At 2500, the availability indication logic 332c of the activity based availability indication system provides an indication of a current availability level on a device operated by the specific user. Thus, for example, the availability indication logic 332c may cause an indication to be displayed on a monitor or display 102b operated by the specific user, providing the specific user with feedback regarding the determined current activity and allowing the specific user to correct such should the determined current activity be incorrect. Such could also be displayed on another type of electronic device, for instance a wireless communications device operated or logically associated with the specific user.

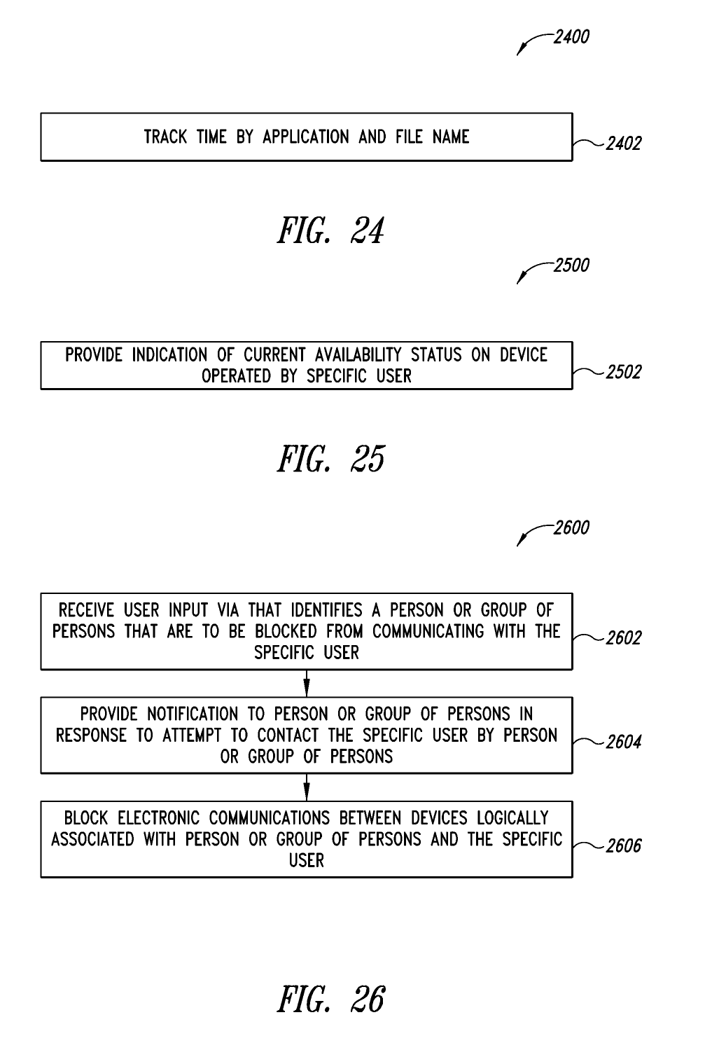

FIG. 26 shows a method 2600 of suppressing electronic communications in an activity based availability indication system, according to one illustrated embodiment. The method 2600 may be performed as part of the method 400 (FIG. 4).

At 2602, the availability configuration logic 332a of the activity based availability indication system receives at least one user input via the at least one user interface that identifies at least one of a person or a group of persons that are to be blocked from communicating with the specific user.

At 2604, the availability indication logic 332c of the activity based availability indication system provides corresponding notification to the person or the group of persons in response to an attempt to contact the specific user by the person or the group of persons.

Optionally at 2606, the communications control logic 332d of the activity based availability indication system blocks electronic communications between devices logically associated with the person or the group of persons and the specific user.

Such allows the specific user to block communications from one or more people, and allow communications from one or more people based on activity and/or availability level. For example, the specific user may chose to allow receipt of electronic communications from a few select people regardless of the activity and/or availability level. The same specific user may chose to allow receipt of electronic communications from only people on a project team when the determined current activity is indicative of performing work on the given project, blocking electronic communications from other people. Such allows highly tailored control over receipt of electronic communications, minimizing disruptions.

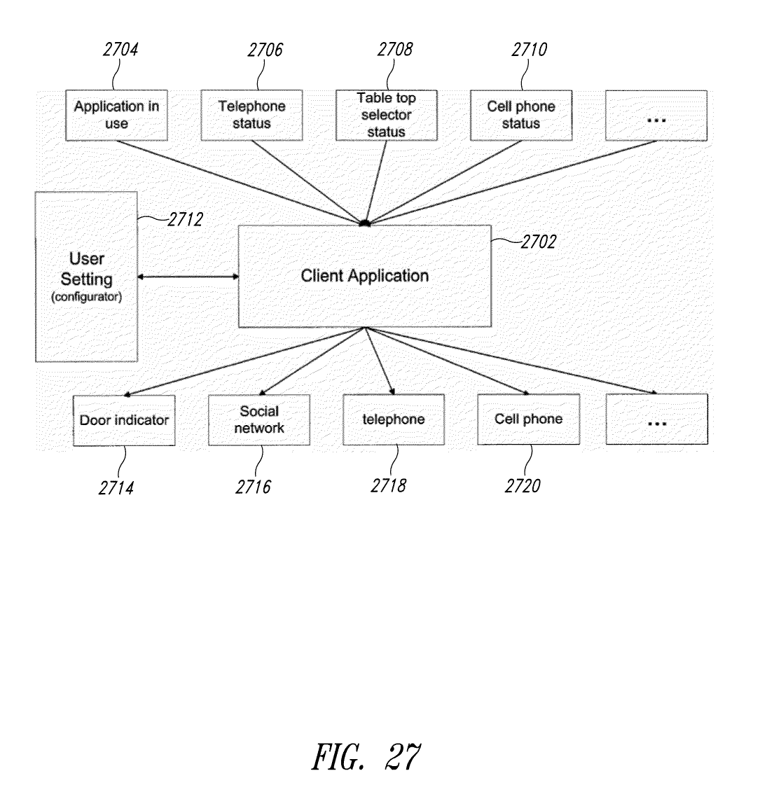

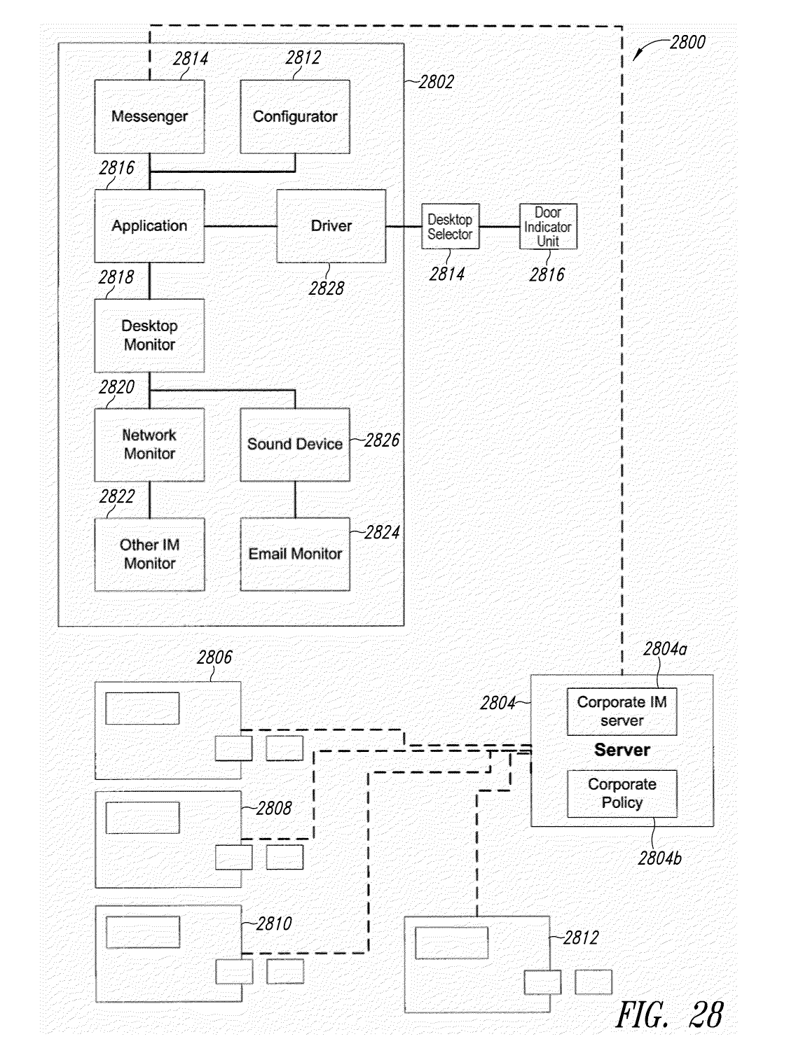

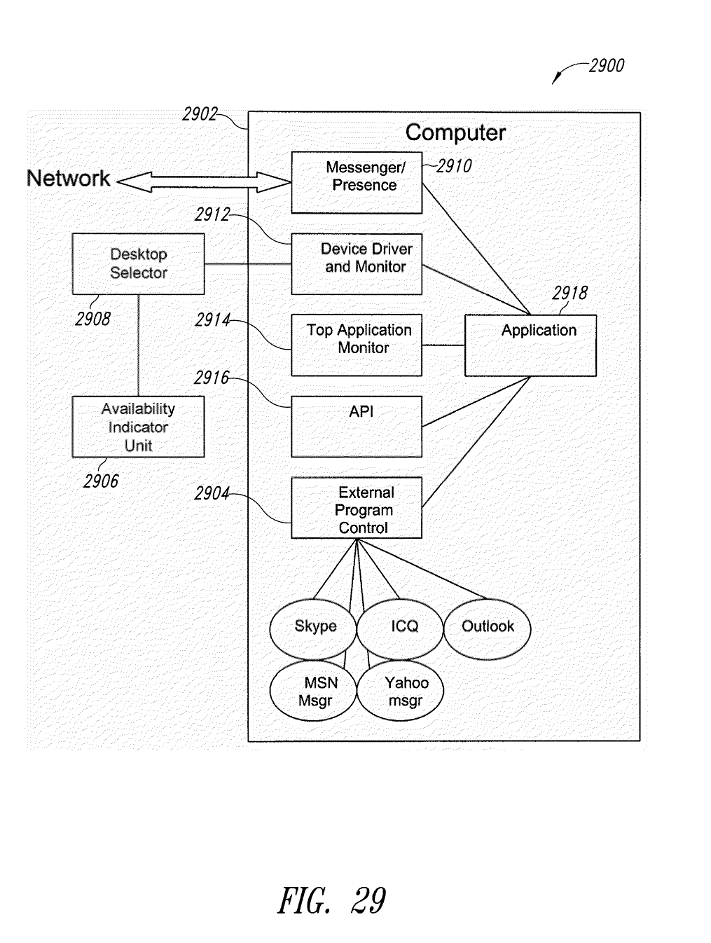

FIGS. 27-34 illustrate a number of different architectures in which the activity based availability indication system may be embodied. Other architectures are of course possible, and the claims should not be limited by the finite number of architectures which may be illustrated and described.

FIG. 27 shows an architecture 2700 of an activity based availability indication system, according to one illustrated embodiment.

The architecture 2700 includes user client application 2702 which allows a specific user, for example a worker, to use automation that changes their availability status base at least in part on a software application that they are currently using. The user client application 2702 gathers or receives input from various sources, such input includes but is not limited to: application currently in use 2704, telephone status 2706, desktop selector status 2708, cell phone status 2710 and user settings 2712 via a user setting device or configurator. The client application 2702 controls a door indicator 2714, messenger 2716, telephone 2718 and cell phone 2720. In various embodiments, the client application 2702 interfaces with various operating systems (e.g., WINDOWS®, OS-X®, LINUX® to seamlessly control all instant messaging, for instance MSN Messenger®, SKYPE®, ICQ®, YAHOO! Messenger®, GOOGLETALK® and other's presence status. In various embodiments, the client application 2702 may also interact with corporate mail and calendar services, for example those hosted on a MICROSOFT® Exchange Server. In various embodiments, the client application 2702 may also interact with unified communication servers, for example MICROSOFT® Communicator®, IBM SAMETIME®, Avaya One-X® and others, setting user's presence state in synchronization with a device. In various embodiments, the client application 2702 may also interact with corporate director servers, for example LDAP®, ACTIVEDIRECTORY®, and others, setting user's presence state in synchronization with a device. In various embodiments, the client application 2702 may also interact with corporate telephone system (PBX) or individual phone lines. In various embodiments, the client application 2702 may also interact with electronic mail or e-mail software, to block notification (alerts) and/or receipt of electronic mail or email and/or fetching of same.

The user client application 2702 identifies the particular application with which the specific user is currently working and according to a predefined setting, set by the specific user or the corporate administrator, changes the availability status of the door indicator 2714, suppresses or permits incoming calls via telephone line 2718 and/or cell phone 2720, blocks or permits Web messenger(s) 2716 to pass messages, blocks or permits receipt of incoming emails and other electronic correspondence that tends to interrupt the specific user.

FIG. 28 shows a corporate high level architecture 2800 of an activity based availability indication system, according to one illustrated embodiment.

A user client application 2802 installed on a computer used by or logically associated with a specific user includes one or more interfaces to various electronic devices, as well as to a company server 2804. The company server 2804 may implement an instant messaging (IM) server 2804a, and/or may store and implement a corporate policy 2804b, including rules and default values for activities, availability statuses or levels, suppression of electronic communications and acceptable relationships therebetween. The corporate policy 2804b may also define clients, projects, teams, work groups, and/or departments. The company server 2804 communicatively couples a computer which the user client application 2802 executes with other users 2806, 2808, 2810, 2812.

The user client application 2802 provides notification of a current availability state or level of a specific user to the other user client applications 2806-2812 through the company server 2804. The other user client applications 2806-2812 may be communicatively coupled to respective availability indication devices and/or desktop selectors (not called out in Figure). The user client application 2802 may also communicate with a desktop selector 2814 that allows the specific user to configure activities, availability statuses or levels, availability messages, and suppression of electronic communications, as well as a current activity and/or current availability status or level. The desktop selector 2814 is communicatively coupled to an availability indication unit 2816, for example an availability indication unit mounted at least proximate a door or portal, and provides signals indicative of an availability status or level for display by the availability indication unit 2816 to peers and colleagues.

The user client application 2800 may include a configurator 2812 to set user settings. The user client application 2800 may include a messenger 2814 to communicate with the corporate IM server 2804a. The user client application 2800 may include an application module 2816 to determine which applications are executing, which window is active, which application has received user input and/or a duration since a user input was received. The user client application 2800 may include a desktop monitor 2818 to monitor the status of various devices on or proximate the desktop. The user client application 2800 may include a network monitor 2820 to monitor the status of one or more networks. The user client application 2800 may include an IM monitor 2822 to monitor IM traffic other than that from the corporate IM server 2804a. The user client application 2800 may include an email monitor 2824 to monitor email traffic to the user's computer. The user client application 2800 may includes a sound device module 2826 to control the production of sounds. The user client application 2800 may include a driver 2828 to drive the availability indication unit 2816 and/or desktop selector 2814.

FIG. 29 shows a high level architecture 2900 of a user client application operating on a computer 2902, according to one illustrated embodiment.

An external program control routine 2904 may be universal, communicating with any application that the corporation or other organization may use, for example OUTLOOK®, GOOGLETALK®, SKYPE® and/or any other program the users may use. A status indicator 2906 may have two or more states that provide an availability indication indicative of an availability status or level of the specific user. The status indicator 2906 could be either flags that carry availability messages such as “busy”, “available”, “busy in project X”, “in a meeting” or other availability messages that allow others to determine the user's availability. The status indicator 2906 could include one or more LCDs or LEDs configured to display the availability messages that are set by the user or authorized persons to reflect the specific user's actual availability. The indicator may receive information via wire or wirelessly. The status indicator 2906 may retrieve the messages directly from the user's calendar and post the availability messages. The availability messages may be such that others could understand the essence of the user activity (e.g., type, task or project), and assess based on such whether an interruption would benefit themselves as well as the specific user. A desktop selector 2908 enables the user to manually change their availability status or level.

The desktop selector 2908 may include either two or more state selectors or an electronic unit that allows defining any desire availability status or level. The desktop selector 2908 could be communicatively coupled to a computer logically associated with or used by the specific user. For example the desktop selector may be communicatively coupled to the computer 2902 via a USB port, parallel port, I@C or any other I/O port or, wirelessly via BLUETOOTH® communication protocol or radio or optical communications protocols.

A messenger/presence module 2910 may provide communications over a network. A device driver and monitor module 2912 may drive and/or monitor the availability indication unit 2906 and/or desktop selector 2908. A top application monitor 2914 determines an active application or window on the user's computing system 2902. An application programming interface 2916 provides a set of functions, procedures or classes that an operating system, library or service provides to support requests made by various programs or applications executing on the user computing system 2902. All of which are under control of or communicate with the application 2918.

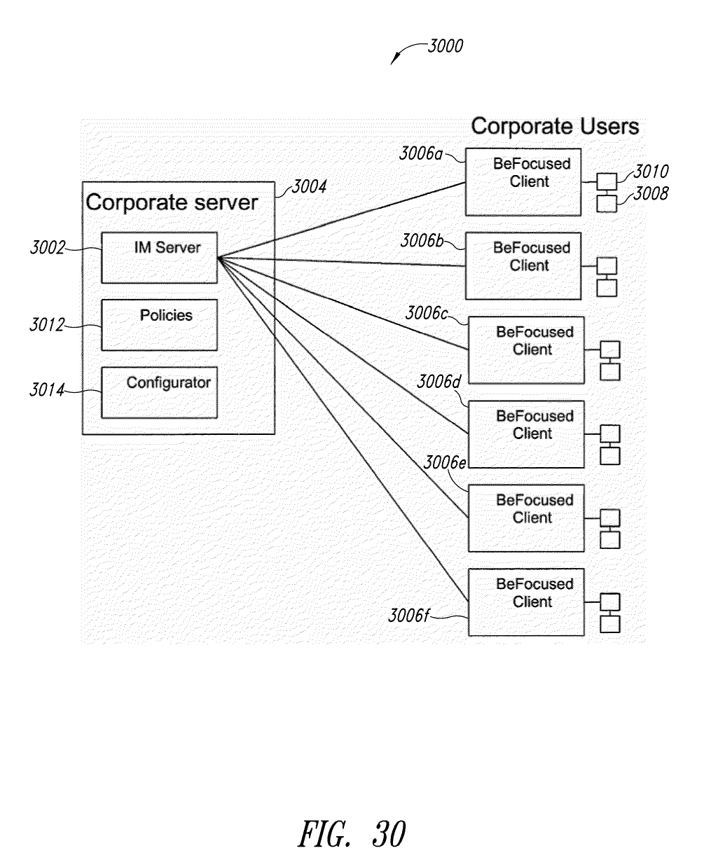

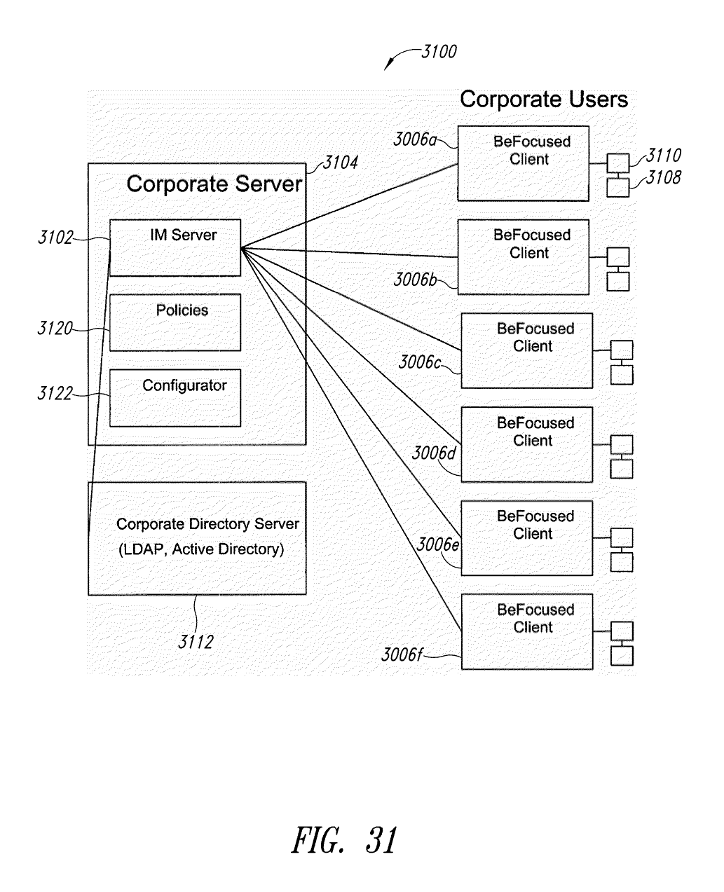

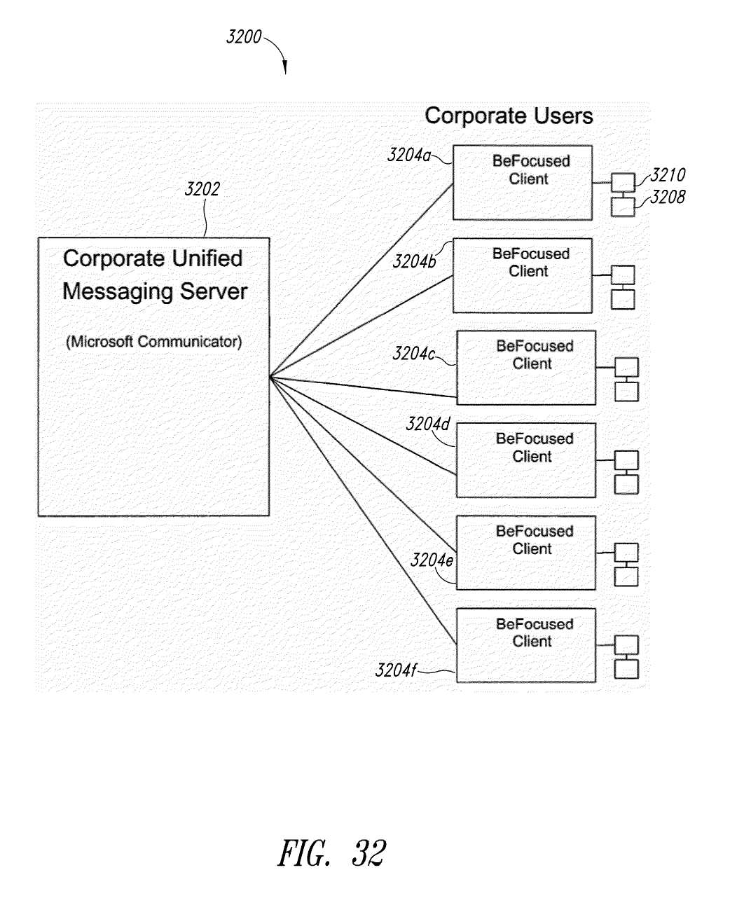

FIGS. 30-33 illustrate various server configurations. Upon input from a specific users, the server notifies other users regarding their colleagues' availability. The server not only indicates availability status or level but may also suppress (e.g., stop alerts, block) or allows electronic communications, for example local and web communication such as electronic mail (i.e., email), messengers, VOIP, etc. The server can be connected to the cellular network and control cellular traffic, for instance SMS (Short Message Service) or phone calls. Different configurations of the server allow definition of working groups, the members of which possess different privileges with respect to interrupting each other. The definition could be set by the organization (e.g., administrator) per specific projects, tasks and duties of each work group.

FIG. 30 shows a standalone corporate architecture 3000, according to one illustrated embodiment.

In particular, an IM server system 3002 executing stand alone on the corporate server 3004, communicatively interacts with a number of user client applications 3006a-3006f (collectively 3006). The user client applications 3006 are executing on one or more computing systems, typically on a respective computing system logically associated with a respective user. The user client applications 3006 are communicatively coupled to respective availability indication units 3008 (only one called out in Figure) and desktop selector units 3010 (only one called out in Figure).

As explained above the corporate server 3004 may store or implement a collection of corporate policies 3012. The corporate server 3004 may include a configurator 3014 operable to configure various activities, availability statuses or levels, electronic communication suppression, as well as relationships between the same.

FIG. 31 shows a standalone corporate architecture 3100 integrated with corporate directory services, according to one illustrated embodiment.

In particular, an IM server system 3102 executing stand alone on the corporate server 3104, communicatively interacts with a number of user client applications 3106a-3106f (collectively 3006). The user client applications 3106 are executing on one or more computing systems, typically on a respective computing system logically associated with a respective user. The user client applications 3106 are communicatively coupled to respective availability indication units 3108 (only one called out in Figure) and desktop selector units 3110 (only one called out in Figure).

The IM server 3102 is communicatively coupled to a corporate directory 3112 to allow the IM server 3102 to provide access between users that are identified in the corporate directory 3112. The IM server 3102 may provide users with availability information regarding other users. The IM server 3102 may provide users with information such as identification of the software application(s) that the other users are using and any defined settings.

As explained above the corporate server 3104 may store or implement a collection of corporate policies 3120. The corporate server 3104 may include a configurator 3122 operable to configure various activities, availability statuses or levels, electronic communication suppression, as well as relationships between the same.

FIG. 32 shows an integrated corporate architecture 3200, according to one illustrated embodiment.

In particular, a corporate main server 3202 communicatively interacts with a number of user client applications 3206a-3206f (collectively 3206). The user client applications 3206 are executing on one or more computing systems, typically on a respective computing system logically associated with a respective user. The user client applications 3206 are communicatively coupled to respective availability indication units 3208 (only one called out in Figure) and desktop selector units 3210 (only one called out in Figure). The corporate main server 3202 is a standard corporate server which may be used to distributed availability messages or information.

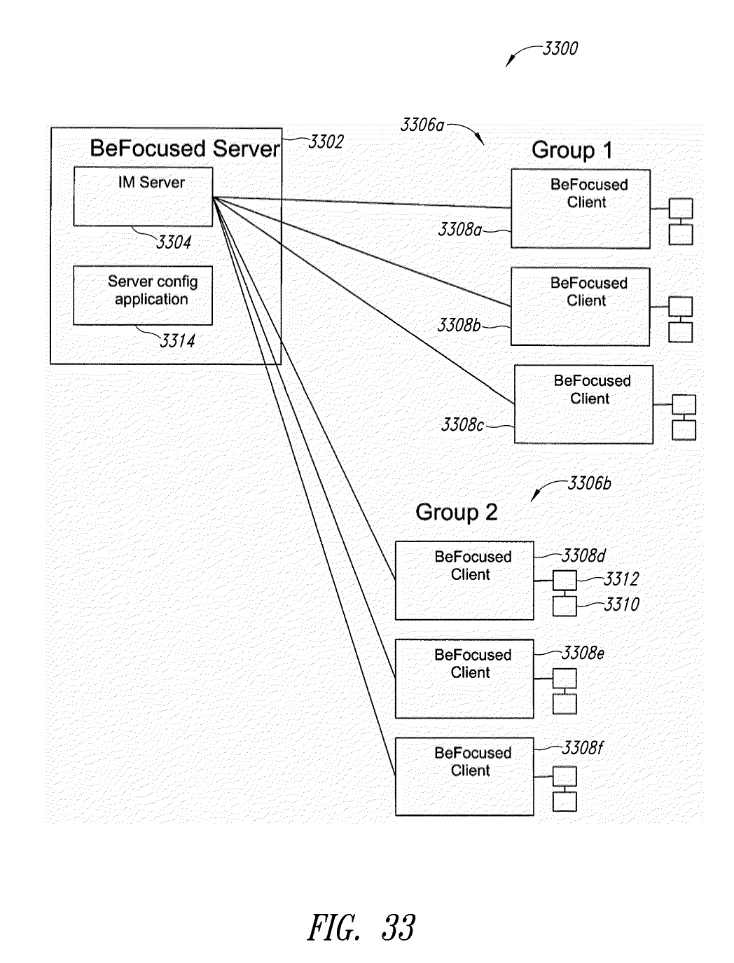

FIG. 33 shows a hosted architecture 3300, according to one illustrated embodiment.

A remotely located server 3302 executes an IM server 3304 that is communicatively coupled to more than one group of users client applications, a first group 3306a including user client applications 3308a-3308c, and a second group 3306b including user client applications 3308d-3308f. The server 3302 could be communicatively coupled to additional groups of user client applications. The user client applications execute on computing systems, which are communicatively coupled to respective availability indication units 3310 (only one called out in Figure) and desktop selector units 3312 (only one called out in Figure). The server 3302 may execute a server configuration application 3314, allowing the server 3302 to configure various activities, availability statuses or levels, electronic communication suppression, as well as relationships between the same.

The desktop selector unit 3312 enables a user to manually select their own current availability status or level. The desktop selector unit 3312 may include a visual interface, for example an LCD or other types of displays. The desktop selector unit 3312 can be programmed and/or set by the user to specify their current activity and/or availability status or level. Typically there are at least two basic availability statuses or levels to select from, which may be denominated as 1) “busy”, “not available”, or “do not disturb”, and 2) “not busy”, “available”, “can disturb”. In some embodiments there may be additional availability statuses or levels, and likewise additional availability messages. For example, a user may select availability statuses or levels such as, but not limited to: “busy on project X”, “in a meeting”, “available for project Y” and so forth. The desktop selector unit 3312 may be communicatively coupled to a computer used by or logically associated with the specific user via any known communications connections, interfaces or protocols, for instance USB, parallel port or BLUETOOTH® wireless interface.

Users may set a mode of the system to determine current activity and/or availability status or level either automatically or manually (e.g., responsive to manual input via an interface such as the desktop selector unit 3312).

An availability indication unit 3310 such as a desktop positioned or door positioned availability indication unit may include a display capable of producing a text format availability message. For example, the availability indication unit 3310 may include an LCD or an LED display, or may include flags that indicate by text and/or color a current availability status of a specific user. The availability indication unit 3310 changes status upon a change in either the desktop status or a status request change set by the user via a computer. The availability indication unit 3310 may be communicatively coupled to the desktop selector 3312 and/or directly to the computer. The communicatively coupling can be wired or wireless.

A telephone line interface (not shown in FIG. 33) may provide a communicative coupling to one or more telephone lines, and may be configured to identify when the telephone line is in use, and in the event of incoming call, to identify a caller identifier. The telephone line interface, upon defined settings and user availability status or level, can suppress (e.g., suppress alerts, block) enable incoming calls or allow such incoming calls. As previously explained, users configure electronic communications suppression in a variety of fashions. For example, a user may allow all incoming calls to go through, block all incoming calls, or allow incoming calls from specific phone numbers to go through while blocking incoming calls from others. The telephone interface may be communicatively coupled to the computer via wired or wireless communications channels using any variety of communication ports or interfaces, for instance USB, parallel port or BLUETOOTH® interface.

A cell phone interface (not shown in FIG. 33) may be communicatively coupled to a cellular network and, like the telephone, can block or pass all incoming calls, or block some incoming calls while passing others according to the telephone number(s) originating the call. The cellular interface may be communicatively coupled to the computer via wired or wireless communications channels using any variety of communication ports or interfaces, for instance the Worldwide Web, USB, parallel port or BLUETOOTH® interface.

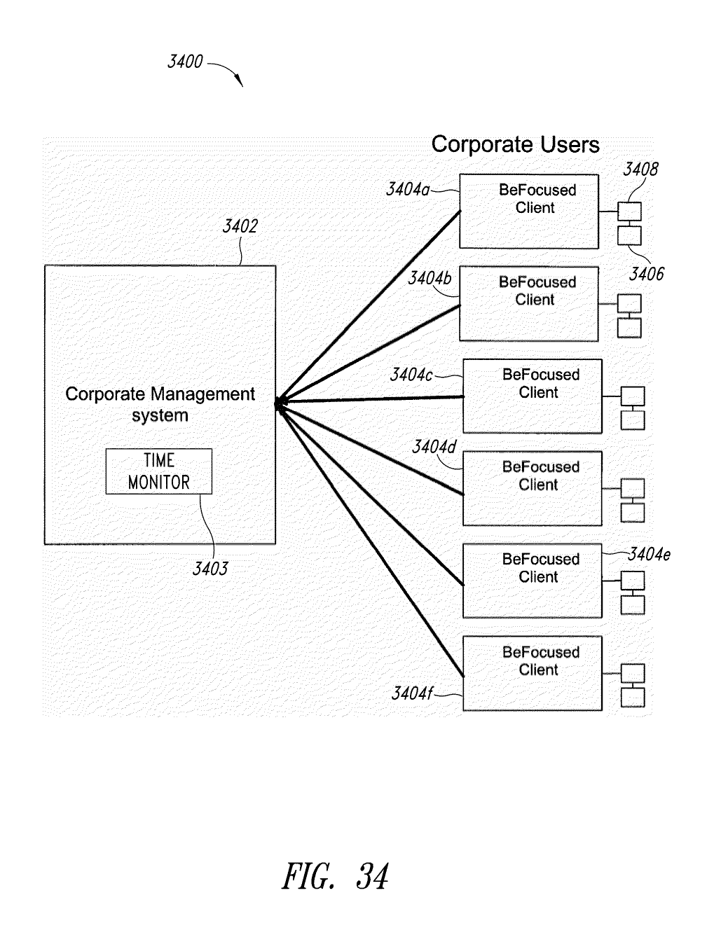

FIG. 34 shows a project/task time recording system 3400, according to one illustrated embodiment. Given the monitoring and information collected in the previous embodiments, it is possible to extend such to include automatically monitoring time for projects or tasks on an individual or even a group basis. Such may be useful in billing or in measuring employee productivity, and may allow better estimating of costs and time for future projects.

A corporate management computing system 3402 executes a time monitor 3403 to gather information indicative of actual time invested in a given project or task by one or more users. User client applications 3404a-3404f (collectively 3404) execute on various computing systems used by or logically associated with various users, which computing systems are communicatively coupled to respective availability indication units 3406 (only one called out in Figure) and desktop selector units 3408 (only one called out in Figure). The user client applications 3404 identify use of various software applications by the users who are working together on a given project or task. The user client applications 3404 can also identify actual file or matter names or identifiers, and send the information to the corporate management server 3402. The corporate management server 3402, having access to defined projects/tasks list with the associated application and file names, can assign the relevant working hours to the given project or task.

Such may provide a number of advantages. For example, such may assure that up-to-date and accurate information is available at any time. Such may eliminate that need for workers and other users to spend time filling out time reports or otherwise recording time. Such an automated process may ensure that time records are correct, with no mistakes due to incorrect reporting based on recollection and assumptions.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other automated systems, not necessarily the exemplary visual notification based time management systems generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing prioritized availability information, the method comprising:
receiving at least one user input via at least one user interface;
mapping a plurality of activities to a number of availability statuses based on the received user input, at least some of the activities associated with specific applications executable on a computing system;
at least partially automatically identifying a currently active activity associated with a specific user; and
providing an indication indicative of an availability status for the specific user based at least in part on the identified currently active activity associated with the specific user and based at least in part on the availability status for the activity specified for the currently active activity status by the mapping.

2. The method of claim 1 wherein at least one of the user inputs is received from a computer logically associated with the specific user.

3. The method of claim 2 wherein at least one of the user inputs is received from a computer that is not logically associated with the specific user.

4. The method of claim 1 wherein mapping a plurality of activities to a number of availability statuses based on the received user input includes mapping a first computer-executable application to a first availability status and mapping a second computer-executable application to a second availability status.

5. The method of claim 1 wherein mapping a plurality of activities to a number of availability statuses based on the received user input includes mapping at least one of a telephone usage activity or a voicemail usage activity to at least one of the availability statuses.

6. The method of claim 1 wherein mapping a plurality of activities to a number of availability statuses based on the received user input includes mapping at least one of a mobile device usage activity to one of the availability statuses.

7. The method of claim 1 wherein mapping a plurality of activities to a number of availability statuses based on the received user input includes mapping at least one of a word processor activity or a spreadsheet activity to at least one of the availability statuses.

8. The method of claim 1 wherein mapping a plurality of activities to a number of availability statuses based on the received user input includes mapping a meeting indicator in an electronic calendar application to one of the availability statuses.

9. The method of claim 1 wherein at least partially automatically identifying a currently active activity associated with a specific user includes automatically identifying any specific applications currently executing on a computer logically associated with the specific user.

10. The method of claim 1 wherein at least partially automatically identifying a currently active activity associated with a specific user includes automatically identifying a specific application associated with a currently selected window on a computer logically associated with the specific user.

11. The method of claim 1 wherein at least partially automatically identifying a currently active activity associated with a specific user includes automatically determining which application executing on a computer logically associated with the specific user received a most recent input.

12. The method of claim 1 wherein at least partially automatically identifying a currently active activity associated with a specific user includes:
automatically determining a duration since a most recent user input to at least one application executing on a computer logically associated with the specific user;
computationally comparing the determined duration to a threshold duration;
identifying the at least one application executing on the computer logically associated with the specific user as not currently active if the determined duration is greater than the threshold duration; and
identifying the at least one application executing on the computer logically associated with the specific user as currently active if the determined duration is not greater than the threshold duration.

13. The method of claim 1, further comprising:
monitoring for additional user inputs on a computer logically associated with the specific user received a most recent input; and
updating the current active activity accordingly.

14. The method of claim 1 wherein providing an indication indicative of an availability status for the specific user includes providing an indication via an indicator positioned at least proximate a location of the specific user.

15. The method of claim 1 wherein providing an indication indicative of an availability status for the specific user includes transmitting a signal to a device from which an inquiry regarding a current available status for the specific user originated.

16. The method of claim 1, further comprising:
presenting a plurality of preconfigured activity and availability relationships for selection via the user interface.

17. The method of claim 1, further comprising:
in response to one of the activities being determined to be the current activity, preventing incoming electronic communications based on a respective one of the availability statuses mapped to the activity.

18. The method of claim 1, further comprising:
in response to one of the activities being determined to be the current activity, preventing alerts to the specific user that are indicative of incoming electronic communications based on a respective one of the availability statuses mapped to the activity.

19. The method of claim 1, further comprising:
receiving at least one user input via the at least one user interface that associates a number of forms of electronic communication that are to be suppressed with at least one of the activities or the availability statuses.

20. The method of claim 1, further comprising:
receiving at least some of the user input from a mobile communications device.

21. The method of claim 1, further comprising:
tracking time by application and file name for billing based on project task list or for productivity tracking

22. The method of claim 1, further comprising:
providing an indication of a current availability status on a device operated by the specific user.

23. The method of claim 1, further comprising:
receiving at least one user input via the at least one user interface that identifies at least one of a person or a group of persons that are to be blocked from communicating with the specific user;
providing corresponding notification to the person or the group of persons in response to an attempt to contact the specific user by the person or the group of persons; and
blocking electronic communications between devices logically associated with the person or the group of persons and the specific user.

24. A system to provide prioritized availability information, the system comprising:
at least one processor;
at least one processor-readable storage device that stores instructions executable by the at least one processor that cause the at least one processor to provide prioritized availability information, by:
receiving at least one user input via a user interface;
mapping a plurality of activities to a number of availability statuses based on the received user input, at least some of the activities associated with specific applications executable on a computing system;
at least partially automatically identifying a currently active activity associated with a specific user; and
providing an indication indicative of an availability status for the specific user based at least in part on the identified currently active activity associated with the specific user and based at least in part on the availability status for the activity specified for the currently active activity status by the mapping.

25. The system of claim 24 wherein the instructions cause the at least one processor to map the plurality of activities to the number of availability statuses by mapping a first computer-executable application to a first availability status and mapping a second computer-executable application executable on a computer to a second availability status

26. The system of claim 24 wherein the instructions cause the at least one processor to map the plurality of activities to the number of availability statuses by mapping at least one of a telephone usage activity or a voicemail usage activity to at least one of the availability statuses

27. The system of claim 24 wherein the instructions cause the at least one processor to at least partially automatically identify the currently active activity associated with the specific user by automatically identifying any specific applications currently executing on a computer logically associated with the specific user

28. The system of claim 24 wherein the instructions cause the at least one processor to at least partially automatically identify the currently active activity associated with the specific user by automatically identifying a specific application associated with a currently selected window on a computer logically associated with the specific user.

29. The system of claim 24 wherein the instructions cause the at least one processor to at least partially automatically identify the currently active activity associated with the specific user by automatically determining which application executing on a computer logically associated with the specific user received a most recent input.

30. The system of claim 24 wherein the instructions cause the at least one processor to at least partially automatically identify the currently active activity associated with the specific user by:
automatically determining a duration since a most recent user input to at least one application executing on a computer logically associated with the specific user;
computationally comparing the determined duration to a threshold duration; and identifying the at least one application executing on the computer logically associated with the specific user as not currently active if the determined duration is greater than the threshold duration; and
identifying the at least one application executing on the computer logically associated with the specific user as currently active if the determined duration is not than the threshold duration.

31. The system of claim 24, further comprising:
an indicator positioned at least proximate a location of the specific user.

32. The system of claim 24 wherein the instructions cause the at least one processor to provide the indication indicative of the availability status for the specific user by transmitting a signal to a device from which an inquiry regarding a current available status for the specific user originated.

33. The system of claim 1, further comprising:
a module;
at least one user operable input device carried by the module selectively operable to provide a user input indicative of an availability status;
at least one communications port carried by the module, the port to provide communicative coupling with at least one peripheral electronic device; and
a knob selectively operable to control at least one aspect of the at least one peripheral electronic device.
